(19) United States
(12) Patent Application Publication
(10) Pub. No.: US 2024/0289741 A1
(43) Pub. Date: Aug. 29, 2024

(54) DIGITAL CONTENT COLLECTION SYSTEM AND METHOD

(71) Applicant: Seong Jun YU, Busan (KR)

(72) Inventor: Seong Jun YU, Busan (KR)

(21) Appl. No.: 18/179,073

(22) Filed: Mar. 6, 2023

(30) Foreign Application Priority Data
Feb. 23, 2023 (KR) 10-2023-0024205

(51) Int. Cl. G06Q 10/087; G06K 7/10; G06K 7/14

(52) U.S. Cl. CPC G06Q 10/087; G06K 7/10297; G06K 7/1417

(57) ABSTRACT

Provided are a system and a method for collecting a digital content, and more particularly, a system and a method for collecting a digital content, which can access digital contents through reading of an NFC tag attached to a product or enclosed along with the product by associating an offline product and the digital contents, and collect the accessed digital contents through scanning of a QR code attached to the product or enclosed along with the product. It is possible to contribute to the increase in marketing and sales of product sellers through the associating of offline products and digital contents, as well as to meet the desire to collect the digital contents of product buyers.

### TECHNICAL FIELD

The present invention relates to a system and a method for collecting a digital content, and more particularly, to a system and a method for collecting a digital content, which can access digital contents through reading of an NFC tag attached to a product or enclosed along with the product by associating an offline product and the digital contents, and collect the accessed digital contents through scanning of a QR code attached to the product or enclosed along with the product.

### BACKGROUND ART

Recently, as the spread of smart devices such as smartphones and tablets has increased, the number of users who use smart devices to access digital content and play or download them has increased.

The digital contents have a characteristic of being able to be accessed by transcending time and space through the media called the Internet. However, the number of systems for owning and collecting the digital contents is insufficient.

Meanwhile, in recent year, there has been a craze for collecting character figures, stickers, and fashion items among MZ generation. They actively find and buy expensive products with scarcity items or fragrances that stimulate the nostalgia of memories. And, the desire for collection of MZ generation is expanding to the digital contents.

Accordingly, this applicant researches and develops a system and a method for collecting a digital content, which can access digital contents through reading of an NFC tag attached to a product or enclosed along with the product by associating an offline product and the digital contents, and collect the accessed digital contents through scanning of a QR code attached to the product or enclosed along with the product.

### SUMMARY OF THE INVENTION

The present invention has been made in an effort to provide a system and a method for collecting a digital content, which can access digital contents through reading of an NFC tag attached to a product or enclosed along with the product by associating an offline product and the digital contents, and collect the accessed digital contents through scanning of a QR code attached to the product or enclosed along with the product.

In order to achieve the object, exemplary embodiments of the present invention provide a system for collecting a digital content, which includes: a user terminal 100; and a manager server 200 which communicates with the user terminal 100 through a wired/wireless communication network 1, in which the user terminal 100 includes a user information input unit 110 receiving user information and transmitting the user information to a user information DB 210, a content categorization output unit 120 categorizing and outputting information on all digital contents in communication with an original content DB 220, a collection request input unit 130 receiving, when reading an NFC tag 11 attached to a product 10 or enclosed along with the product 10, a collection request of the digital contents based on information stored in the NFC tag 11 in communication with the original content DB 220, a shooting screen output unit 140 outputting a shooting screen of a camera module for scanning the QR code 12 attached to the product 10 or enclosed along with the product 10 when receiving the collection request, a collection completion guide unit 150 informing that the digital contents for which the collection request is input are collected when scanning the QR code 12, and a collection list output unit 160 outputting a list for the collected digital contents and a list for digital contents which are not collected in communication with the collection content DB 230, and the manager server 200 includes a user information DB 210 storing the user information transmitted from the user information input unit 110, an original content DB 220 prestoring the digital contents based on the information stored in the NFC tag 11, and a collection content DB 230 storing the collection information for the collected digital contents by scanning the QR code 12, and a method for collecting a digital content, which includes: a user information input step S100 of receiving, a user terminal 100, user information; a user information transmission step S200 of transmitting the received user information to a user information DB 210; a content categorization output step S300 of categorizing and outputting to the user terminal 100 information on all digital contents in communication with an original content DB 220; an NFC tag reading step S400 of reading an NFC tag 11 attached to a product 10 or enclosed along with the product 10; a user request input step S500 of receiving a collection request or an execution request of digital contents based on information stored in the read NFC tag 11 in communication with the original content DB 220; a shooting screen output step S600 of outputting, to the user terminal 100, to a shooting screen of a camera module for scanning a QR code 12 attached to the product 10 or enclosed along with the product 10 when receiving the collection request; a collection content storing step S700 when scanning the QR code 12 in which i) when the digital contents for which the collection request is input are free, the digital contents are immediately stored in the collection content DB 230, and ii) when the digital contents for which the collection request is input is paid, a payment request is received and digital contents for which payment is completed by performing payment are stored in the collection content DB 230; a collection completion guide step S800 of informing the user terminal 100 that the digital contents stored in the collection content DB 230 are collected; a collection list output step S900 of outputting, to the user terminal 100, a list for collected digital contents and a list for digital contents which are not collected in communication with the collection content DB 230; a collection information output step S1000 of outputting, to the user terminal 100, detailed information including information on titles and categories for the collected digital contents in communication with the collection content DB 230; a non-collection information output step S1100 of outputting, to the user terminal 100, detailed information including information on a purchase cost and a purchase place for the product 10 which is accessible to the digital contents which are not collected in communication with the collection content DB 230; and an advertisement providing step S1200 of providing, to the user terminal 100, an advertisement for a product in which a user is sufficiently interested by analyzing the user information stored in the user information DB 210 and the digital contents stored in the collection content DB 230.

According to exemplary embodiments of the present invention, it is possible to contribute to the increase in marketing and sales of product sellers through associating of offline products and digital contents, as well as to meet the desire to collect the digital contents of product buyers.

### BRIEF DESCRIPTION OF THE DRAWINGS

FIG. 1 is a configuration diagram of a system for collecting digital contents according to the present invention.

FIG. 2 is an exemplary diagram for an offline product to which the present invention is applied.

FIG. 3 is a configuration diagram of a user terminal which is a partial component of the present invention.

FIG. 4 is a flowchart of a method for collecting digital contents according to the present invention.

FIG. 5 is an exemplary diagram of a content categorization output unit of the present invention.

FIG. 6 is an exemplary diagram of a collection request input unit and an execution request input unit of the present invention.

FIG. 7 is an exemplary diagram illustrating a shooting screen output by a shooting screen output unit of the present invention.

FIG. 8 is an exemplary diagram of a collection completion guide unit of the present invention.

FIG. 9 is an exemplary diagram of a collection list output unit of the present invention.

FIG. 10 is an exemplary diagram of a collection information output unit of the present invention.

FIG. 11 is an exemplary diagram of a non-collection information output unit of the present invention.

### DETAILED DESCRIPTION

Hereinafter, preferred embodiments of the present invention will be described with reference to the accompanying drawings. However, the scope of the rights of the present invention should be identified by the disclosure of claims. In addition, the description of the known technology that blurs the point of the present invention is omitted.

However, since size and thickness of each component illustrated in the drawings are arbitrarily represented for convenience in explanation, the present invention is not particularly limited to the illustrated size and thickness of each component and the thickness is enlarged and illustrated in order to clearly express various parts and areas.

The present invention relates to a system and a method for collecting a digital content, and more particularly, to a system and a method for collecting a digital content, which can access digital contents through reading of an NFC tag attached to a product or enclosed along with the product by associating an offline product and the digital contents, and collect the accessed digital contents through scanning of a QR code attached to the product or enclosed along with the product.

In the present invention, digital contents mean online contents that may be accessed through wired and wireless communication networks, and is a concept that includes digital contents such as pictures, photos, sound sources, videos, games, as well as VR, AR, and XR.

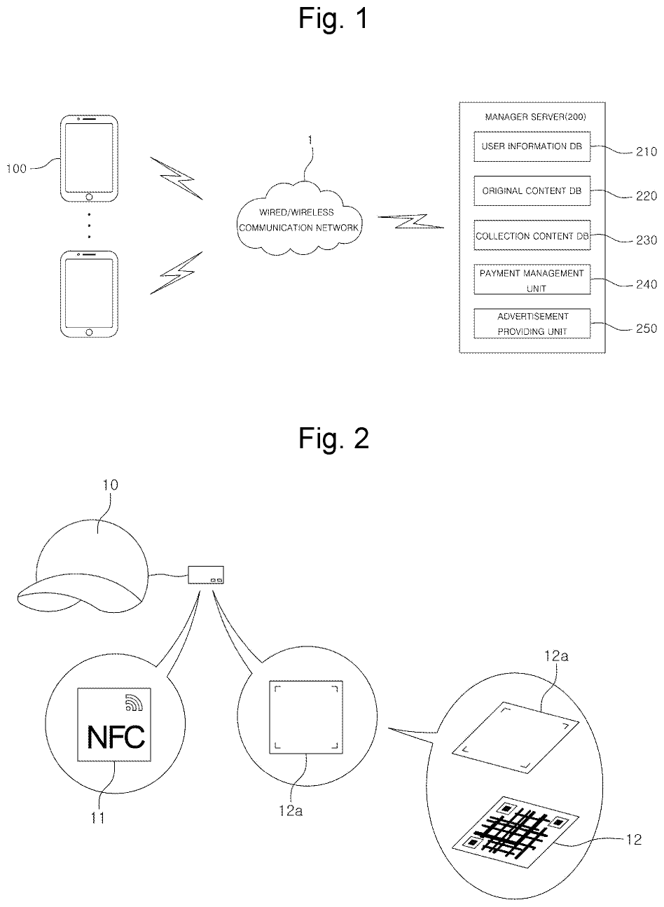

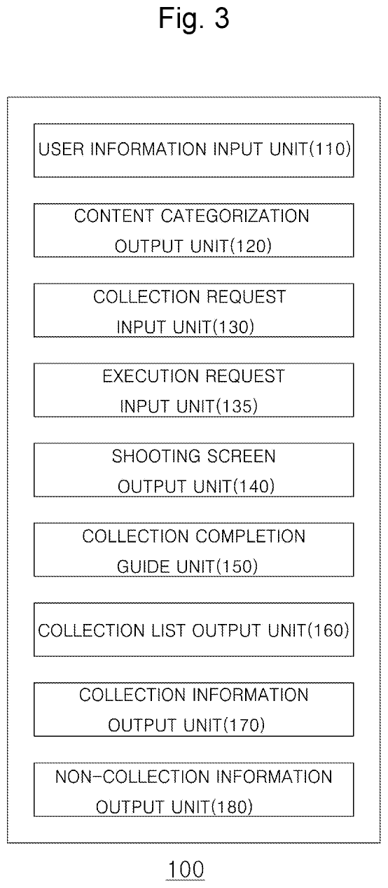

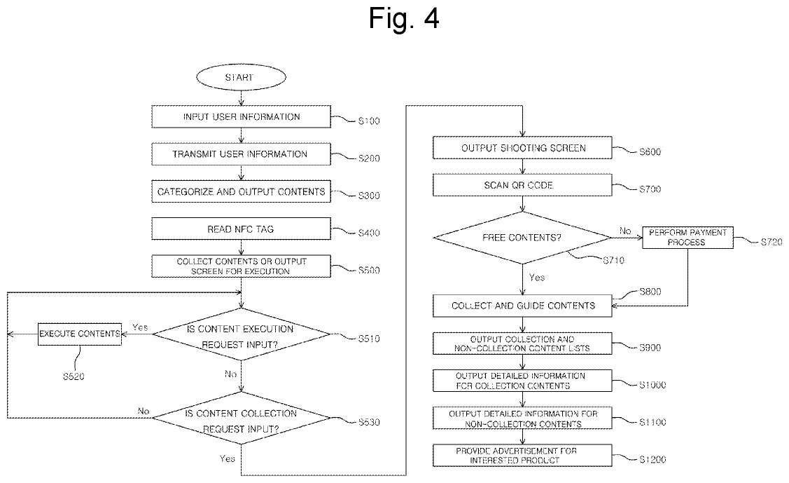

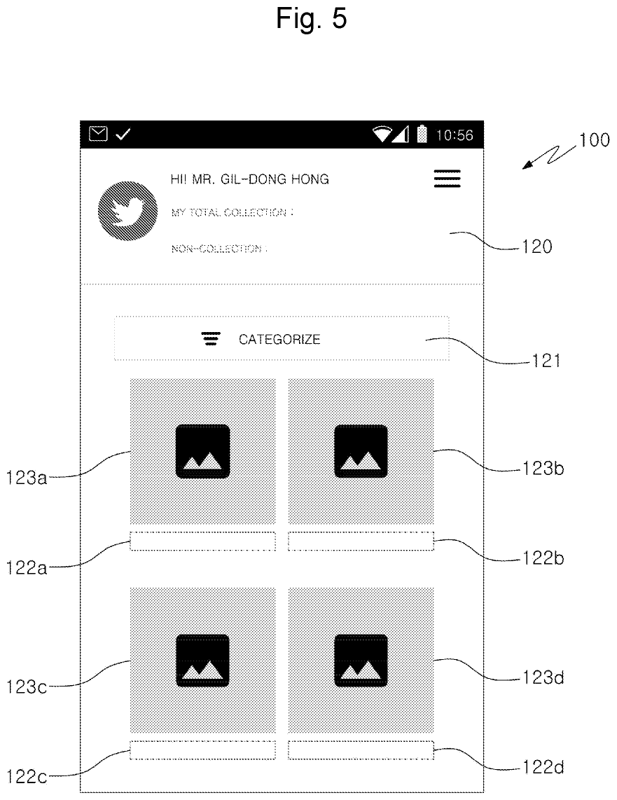

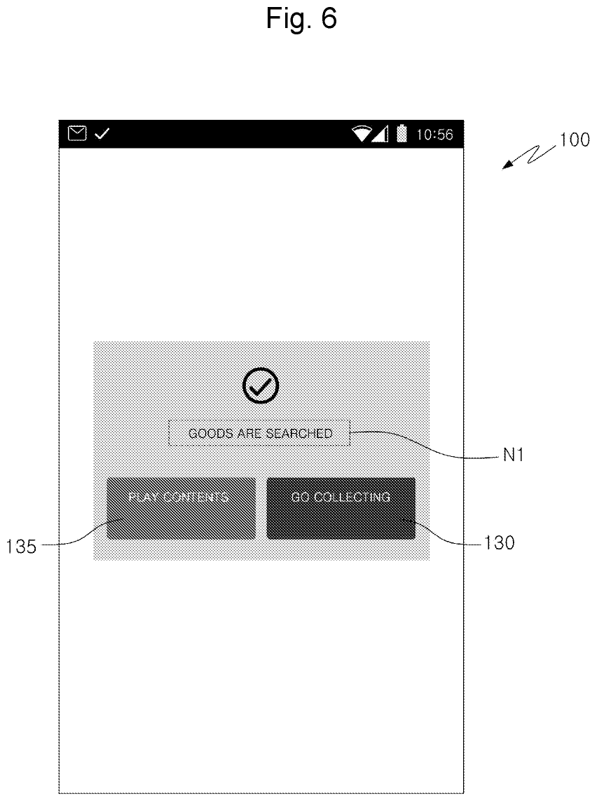

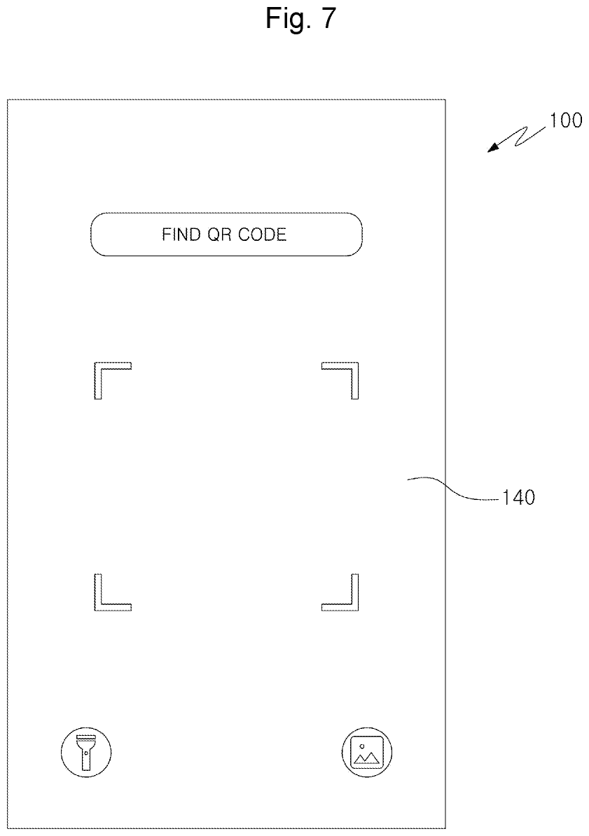

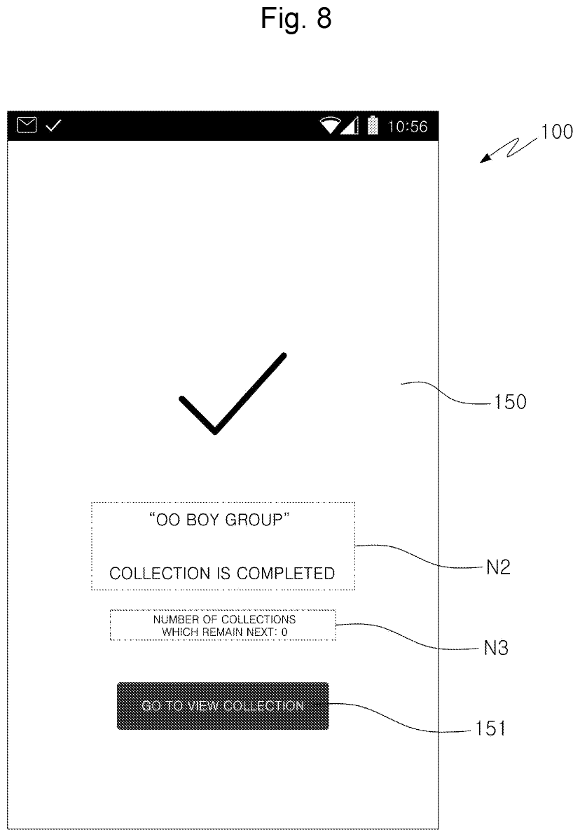

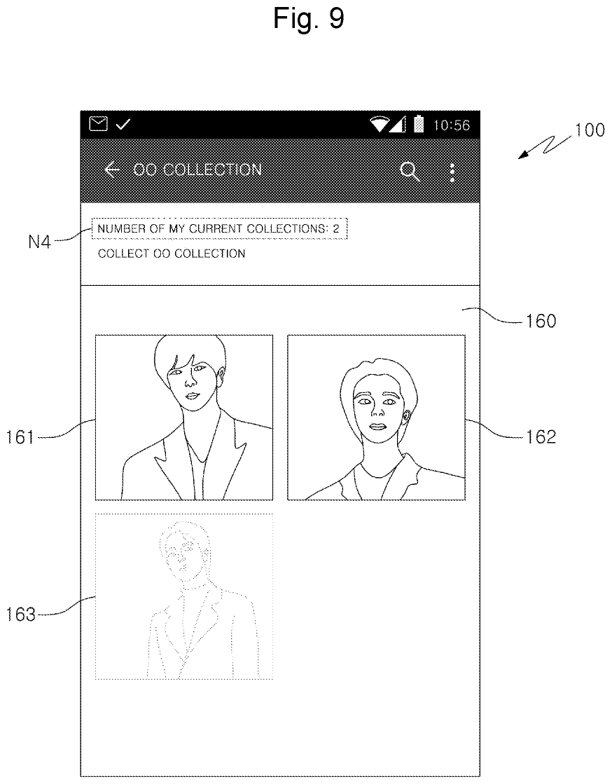

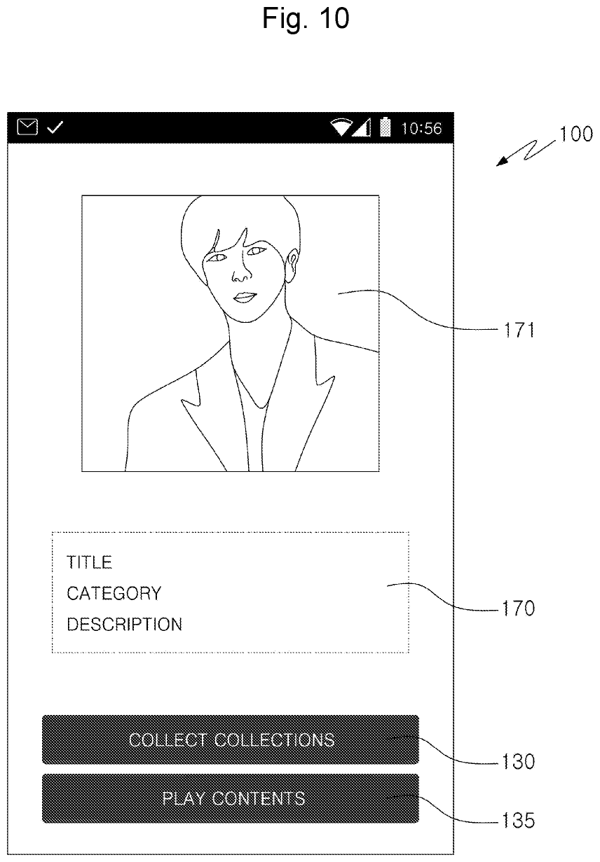

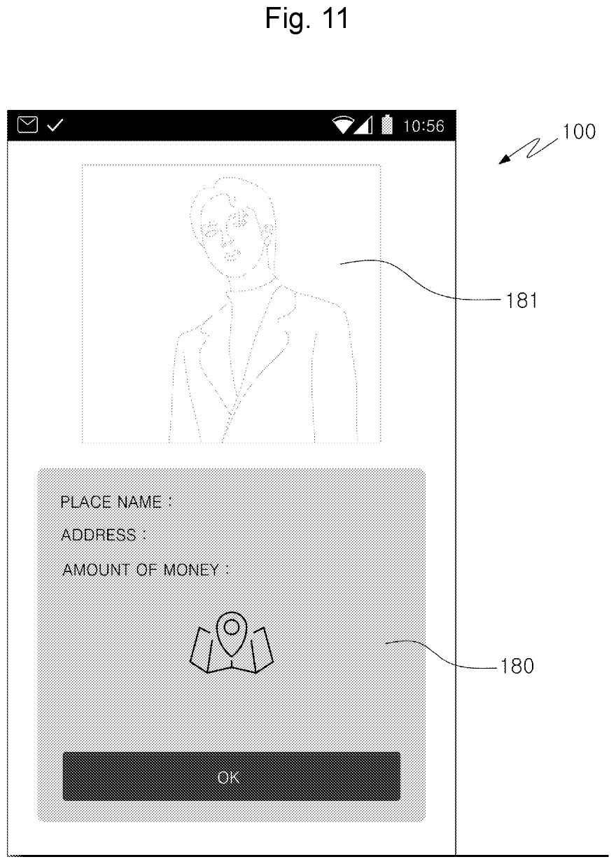

FIG. 1 is a configuration diagram of a system for collecting digital contents according to the present invention, FIG. 2 is an exemplary diagram for an offline product to which the present invention is applied, FIG. 3 is a configuration diagram of a user terminal which is a partial component of the present invention, FIG. 4 is a flowchart of a method for collecting digital contents according to the present invention, FIG. 5 is an exemplary diagram of a content categorization output unit of the present invention, FIG. 6 is an exemplary diagram of a collection request input unit and an execution request input unit of the present invention, FIG. 7 is an exemplary diagram illustrating a shooting screen output by a shooting screen output unit of the present invention, FIG. 8 is an exemplary diagram of a collection completion guide unit of the present invention, FIG. 9 is an exemplary diagram of a collection list output unit of the present invention, FIG. 10 is an exemplary diagram of a collection information output unit of the present invention, and FIG. 11 is an exemplary diagram of a non-collection information output unit of the present invention.

The digital content collecting system according to the present invention may be configured to include a user terminal 100, and a manager server 200 which communicates with the user terminal 100 through a wired/wireless communication network 1 as illustrated in FIG. 1.

Here, the wireless communication network includes Wireless LAN (WLAN), Digital Living Network Alliance (DLNA), Wireless Broadband (Wibro), World Interoperability for Microwave Access (Wimax), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), etc., and communication is made according to at least one wireless Internet technology in a range including even an Internet technology which is not enumerated.

The user terminal 100 is described. The user terminal 100 means a portable terminal which may communicate with the manager server 200 such as a smartphone, a tablet, etc., and is preferably equipped with an NFC function for reading near field communication (NFC) and a camera module for scanning a quick response (QR) code.

FIG. 2 is an exemplary diagram for an offline product to which the present invention is applied. That is, a core element of the present invention is that the user terminal 100 communicates with the manager server 200 via an NFC tag 11 or a QR code 12 attached to an offline product 10.

The user terminal 100 may be configured to include a user information input unit 110, a content categorization output unit 120, a collection request input unit 130, an execution request input unit 135, a shooting screen output unit 140, a collection completion guide unit 150, a collection list output unit 160, a collection information output unit 170, and a non-collection information output unit 180, as illustrated in FIG. 3.

The user information input unit 110 is described. The user information input unit 110 is a part that receives user information and transmits the user information to a user information DB 210 of the manager server 200.

Here, the user information may also include information on an interested product, interested contents, etc., in addition to information on basic personal information such as age, gender, etc. The user information may be written while membership registration through a dedicated application.

The content categorization output unit 120 is described. The content categorization output unit 120 is a part that communicates with an original content DB 220 of the manager server 200 to categorize and output information on all digital contents.

FIG. 5 is an exemplary diagram of a content categorization output unit 120 of the present invention. For example, in FIG. 5, a categorization tab 121 is categorized into sports/movies/music/games, so that any of them may be selected.

If ‘sports’ is selected from the category tab 121 categorized into sports/movies/music/games, etc., respective sub-items 122a, 122b, 122c, and 122d may be enumerated as football/basketball/baseball/volleyball. Further, thumbnail images for the respective sub-items 123a, 123b, 123c, and 123d may also be output.

The categorization tab 121, the respective sub-items 122a, 122b, 122c, and 122d, and the thumbnail images 123a, 123b, 123c, and 123d for the respective sub-items may be continuously updated by a manager, of course.

The collection request input unit 130 is described. The collection request input unit 130 is a part that communicates with the original content DB 220 of the manager server 200 to receive a collection request for the digital contents based on information stored in the NFC tag 11 when reading the NFC tag 11 attached to the product 10 or enclosed along with the product 10.

FIG. 2 is an exemplary diagram for an offline product to which the present invention is applied. That is, in FIG. 2, it is illustrated that the NFC tag 11 and the QR code 12 are formed on a price tag attached to the product 10. A user may read the NFC tag 11 attached to the product 10 using the user terminal 100 with the NFC function.

On the other hand, in FIG. 2, the QR code 12 is illustrated not to be exposed to the outside by a shielding means 12a such as a shielding seal, which is to prevent the user from scanning the QR code 12 while not purchasing the product 10 displayed on the outside. Although not illustrated in the figure, if the NFC tag 11 and the QR code 12 are enclosed along with the product 10 in a box, the shielding means 12a may not be present.

The execution request input unit 135 is described. The execution request input unit 135 is a part that communicates with the original content DB 220 of the manager server 200 and receives an execution request for the digital contents based on the information stored in the NFC tag 11 when reading the NFC tag 11 attached to the product 10.

FIG. 6 is an exemplary diagram of a collection request input unit 130 and an execution request input unit 135 of the present invention. When the user inputs the collection request of the digital contents through the collection request input unit 130, the user terminal 100 proceeds to a step for scanning the QR code 12, and when the user inputs the execution request of the digital contents through the execution request input unit 135, the digital contents are executed. In addition, a sentence N1 indicating that that NFC tag 11 is normally read may also be displayed along with the collection request input unit 130 and the execution request input unit 135.

Here, a meaning that the digital contents are executed depends on the type of content. If the digital contents are a sound source or video, the execution of the digital contents means playing the sound source or video, and if the digital contents are a game, the execution of the digital contents means downloading the game.

Then, after the execution of the digital content is completed, the user terminal 100 may be configured to return to a screen where the collection request input unit 130 and the execution request input unit 135 are output as illustrated in FIG. 6 again.

The shooting screen output unit 140 is described. The shooting screen output unit 140 is a part that outputs the shooting screen of the camera module for scanning the QR code 12 attached to the product 10 or enclosed along with the product 10 when receiving the collection request of the digital contents.

FIG. 7 is an exemplary diagram illustrating a shooting screen output by a shooting screen output unit 140 of the present invention. The shooting screen output unit 140 may be activated by quick panel icons of the smartphone, the tablet, etc. This is a known technology, so the detailed description is omitted.

If the QR code 12 is not exposed to the outside by the shielding means 12a such as the shielding seal, the user may release the shielding means 12a, and then scan the QR code 12.

The collection completion guide unit 150 is described. The collection completion guide unit 150 is a part that informs that the digital contents for which the collection request is input are collected when scanning the QR code 12 by means of the camera module.

FIG. 8 is an exemplary diagram of a collection completion guide unit 150 of the present invention. As illustrated in FIG. 8, a sentence N2 that informs that the digital contents for which the collection request is input are collected is output from the user terminal 100, and simultaneously, collection information for the digital contents collected by scanning the QR code 12 is stored in the collection content DB 230 by the manager server 200.

Further, the collection completion guide unit 150 may also be configured to move the digital contents to the collection list output unit 160 through a tab of the collection list movement unit 151 at a lower side.

Further, the collection completion guide unit 150 may also output the digital contents along with a sentence N3 that informs of the number of digital contents not collected.

On the other hand, a non-fungible token (NFT) that authenticates an ownership for the product may be obtained based on digital data of the collected digital contents, and a transaction between users may also be configured to be enabled through a dedicated application.

If the digital contents for which the collection request is input is free, the collection completion guide unit 150 informs that the digital contents are collected when scanning the QR code 12 by means of the camera module, but if the digital contents for which the collection request is input is paid, the collection completion guide unit 150 receives a payment request when scanning the QR code 12 by means of the camera module, and informs that the digital contents for which payment is completed are collected by performing payment.

The collection list output unit 160 is described. The collection list output unit 160 is a part that communicates with the collection content DB 230 of the manager server 200 to output a list for the collected digital contents and a list for the digital contents which are not collected.

FIG. 9 is an exemplary diagram of a collection list output unit 160 of the present invention.

As illustrated in FIG. 9, the collection list output unit 160 may output thumbnail images 161 and 162 for the collected digital contents with a dark line, and output a thumbnail image 163 for the digital contents not collected with a light line.

Although not illustrated in the figure, the collection list output unit 160 may output the thumbnail images for the collected digital contents with a color and output the thumbnail image for the digital contents which are not collected with black and white.

Further, the collection list output unit 160 may also output a sentence N4 that informs of the number of digital contents which are currently collected jointly.

The collection information output unit 170 is described. The collection information output unit 170 is a part that communicates with the collection content DB 230 of the manager server 200 to output detailed information including information on titles and categories for the collected digital contents.

The collection information output unit 170 may be configured to move by touch-operating any one of the thumbnail images 161 and 162 for the digital contents output to be collected by the collection list output unit 160.

FIG. 10 is an exemplary diagram of a collection information output unit 170 of the present invention. In FIG. 10, detailed information including the title, the category, and a description means information prestored in the original content DB 220 of the manager server 200. Meanwhile, the collection request input unit 130 and the execution request input unit 135 may also be configured to be simultaneously output at the lower side of the collection information output unit 170.

Further, the collection information output unit 170 may also output a thumbnail image 171 for the collected digital contents jointly. For example, the thumbnail image 171 may correspond to the thumbnail image 161 touch-operated by the collection list output unit 160.

The non-collection information output unit 180 is described. The non-collection information output unit 180 is a part that communicates with the collection content DB 230 of the manager server 200 to output detailed information including information (a store name, a store address, and a map screen) on a purchase cost and a purchase place for a product 10 which is accessible to the digital contents which are not collected.

Here, being capable of accessing the digital contents means being capable of accessing the original content DB 220 of the manager server 200 prestoring the digital contents through reading the NFC tag 11 attached to the product 10 or enclosed along with the product 10 as described above.

The non-collection information output unit 180 may be configured to move by touch-operating the thumbnail image 163 for the digital contents are not to be collected by the collection list output unit 160.

FIG. 11 is an exemplary diagram of a non-collection information output unit 180 of the present invention. Here, the information on the purchase place, i.e., the information on the store name, the store address, and the map screen may be output through a GPS function inherent in the smartphone, the tablet, etc. This is a known technology, so the detailed description is omitted.

Further, the non-collection information output unit 180 may also output a thumbnail image 181 for the digital contents which are not collected jointly. For example, the thumbnail image 181 may correspond to the thumbnail image 163 touch-operated by the collection list output unit 160.

The manager server 200 is described. The manager server 200 as a part that communicates with the user terminal 100 through the wired/wireless communication network 1 may be configured to include a user information DB 210, an original content DB 220, a collection content DB 230, a payment management unit 240, and an advertisement providing unit 250.

The user information DB 210 is described. The user information DB 210 is a part that stores user information transmitted from the user information input unit 110. That is, the user information DB 210 stores user information for each member.

The original content DB 220 is described. The original content DB 220 is a part that prestores the digital contents based on the information stored in the NFC tag 11. A manager may continuously update the digital contents to the original content DB 220 of the manager server 200, and this may be output to the user terminal 100 through the content categorization output unit 120 as described above.

The collection content DB 230 is described. The collection content DB 230 is a part that stores collection information for the digital contents collected by scanning the QR code 12. Collection information for the collected digital contents and non-collected digital contents stored in the collection content DB 230 may be output to the user terminal 100 through the collection list output unit 160 as described above.

The payment management unit 240 is described. The payment management unit 240 is a part for managing a process related to payment of the digital contents which are paid.

Specifically, when any one payment means of payment means preregistered in the user terminal 100 is selected and authentication data including a pre-registered pin number and bio data are input, the payment management unit 240 may allow payment to be conducted by any one selected payment means. This is a known technology, so the detailed description is omitted.

The advertisement providing unit 250 is described. The advertisement providing unit 250 is a part that provides an advertisement for a product which the user is interested in by analyzing the user information stored in the user information DB 210 of the manager server 200 and the digital contents stored in the collection content DB 230 of the manager server 200.

A deep learning algorithm may be used for analysis of the user information and the digital contents conducted by the advertisement providing unit 250, and an advertisement for a product having a highest interest for each gender or each age may be provided to the user according to an analysis result. This is referred to target marketing.

A digital content collecting method according to the present invention will be described with reference to FIG. 4 based on the above-described configuration.

The digital content collecting method according to the present invention may be largely configured to include a user information input step S100, a user information transmission step S200, a content categorization output step S300, an NFC tag reading step S400, a user request input step S500, a shooting screen output step S600, a collection content storing step S700, a collection completion guide step S800, a collection list output step S900, and a collection information output step S1000, a non-collection information output step S1100, and an advertisement providing step S1200.

The user information input step S100 is described. The user information input step S100 is a step in which the user terminal 100 receives user information. As described above, the user information may be input through the user information input unit 110 of the user terminal 100.

The user information transmission step S200 is described. The user information transmission step S200 is a step of transmitting the input user information to the user information DB 210 of the manager server 200. That is, the user information DB 210 stores the user information for each member.

The content categorization output step S300 is described. The content categorization output step S300 is a step of categorizing information on all digital contents and outputting the categorized information to the user terminal 100 in communication with the original content DB 220 of the manager server 200.

For example, in the content categorization output step S300, the digital contents may be categorized into sports/movies/music/games, so that any one of them may be configured to be selected.

The NFC tag reading step S400 is described. The NFC tag reading step S400 is a step of reading the NFC tag 11 attached to the product 10 or enclosed along with the product 10. As described above, the NFC tag 11 may be read by using the user terminal 100 with the NFC function.

The user request input step S500 is described. The user request input step S500 is a step of outputting, to the user terminal 100, a screen for receiving a collection request or an execution request of the digital contents based on information stored in the read NFC tag 11 in communication with the original content DB 220 of the manager server 200.

As described above, when the collection request of the digital contents is input, the user terminal 100 proceeds to the shooting screen output step S600 for scanning the QR code 12 (S530), and when the execution request of the digital contents is input, the digital contents are executed (S510 and S520). In addition, when the execution of the digital contents ends, the user terminal 100 may return to the user request input step S500 again.

The shooting screen output step S600 is described. The shooting screen output step S600 is a step of outputting the shooting screen of the camera module for scanning the QR code 12 attached to the product 10 or enclosed along with the product 10 to the user terminal 100 when the collection request of the digital contents is input.

As described above, the shooting screen for the camera module for scanning the QR code 12 may be activated by the quick panel icons of the smartphone, the tablet, etc.

The collection content storing step S700 is described. The collection content storing step S700 is a step S710, S720, S800 in which i) when the digital contents for which the collection request is input is free, the digital contents are stored in the collection content DB 230 (S710 and S800), and ii) when the digital contents for which the collection request is input is paid, the screen for receiving the payment request is output, and when the payment request is input, digital contents which are payment-completed by performing the payment are stored the collection content DB 230, when the QR code 12 is scanned by means of the camera module.

The collection completion guide step S800 is described. The collection completion guide step S800 is a step in which the user terminal 100 informs that the digital contents stored in the collection content DB 230 of the manager server 200 are collected.

That is, a sentence N2 that informs that the digital contents for which the collection request is input are collected is displayed in the user terminal 100, and simultaneously, collection information for the digital contents collected by scanning the QR code 12 is stored in the collection content DB 230 by the manager server 200.

The collection list output step S900 is described. The collection list output step S900 is a step of outputting, to the user terminal 100, a list for collected digital contents and a list for digital contents which are not collected in communication with the collection content DB 230 storing the information on the collected digital contents.

As illustrated in FIG. 9, in the collection list output step S900, the thumbnail images 161 and 162 for the collected digital contents may be output with the dark line, and the thumbnail image 163 for the digital contents which are not collected may be output with the light line.

Although not illustrated in the figure, in the collection list output step S900, the thumbnail images for the collected digital contents may be output with a color and the thumbnail image for the digital contents which are not collected may be output with black and white.

The collection information output step S1000 is described. The collection information output step S1000 is a step of outputting, to the user terminal 100, detailed information including information on titles and categories for the collected digital contents in communication with the collection content DB 230 of the manager server 200.

Here, the detailed information including the information on the titles and the categories means information prestored in the original content DB 220.

The non-collection information output step S1100 is described. The non-collection information output step S1100 is a step of outputting, to the user terminal 100, detailed information including information (a store name, a store address, and a map screen) on a purchase cost and a purchase place for the product 10 which is accessible to the digital contents which are not collected in communication with the collection content DB 230 of the manager server 200.

Here, being capable of accessing the digital contents means being accessing to the original content DB 220 of the manager server 200 prestoring the digital contents through reading the NFC tag 11 attached to the product 10 or enclosed along with the product 10 as described above.

Here, the information on the purchase place, i.e., the information on the store name, the store address, and the map screen may be output through a GPS function inherent in the smartphone, the tablet, etc.

The advertisement providing step S1200 is described. The advertisement providing step S1200 is a step of providing, to the user terminal 100, an advertisement for a product in which a user is sufficiently interested by analyzing the user information stored in the user information DB 210 of the manager server 200 and the digital contents stored in the collection content DB 230 of the manager server 200.

The analysis of the user information and the digital contents made in the advertisement providing step S1200, may adopt a deep learning algorithm, and the advertisement for the product having a highest interest for each gender or each age may be provided to the user according to an analysis result. This is referred to target marketing.

According to exemplary embodiments of the present invention, it is possible to contribute to the increase in marketing and sales of product sellers through the associating of offline products and digital contents, as well as to meet the desire to collect the digital contents of product buyers.

The present invention is not limited to the aforementioned embodiments and the accompanying drawings, and it will be obvious to those skilled in the technical field to which the present invention pertains that various substitutions, modifications, and changes may be made within the scope without departing from the technical spirit of the present invention.

What is claimed is:

1. A system for collecting a digital content, comprising:
a user terminal 100; and
a manager server 200 which communicates with the user terminal 100 through a wired/wireless communication network 1,
wherein the user terminal 100 includes
a user information input unit 110 receiving user information and transmitting the user information to a user information DB 210,
a content categorization output unit 120 categorizing and outputting information on all digital contents in communication with an original content DB 220,
a collection request input unit 130 receiving, when reading an NFC tag 11 attached to a product 10 or enclosed along with the product 10, a collection request of the digital contents based on information stored in the NFC tag 11 in communication with the original content DB 220,
a shooting screen output unit 140 outputting a shooting screen of a camera module for scanning the QR code 12 attached to the product 10 or enclosed along with the product 10 when receiving the collection request,
a collection completion guide unit 150 informing that the digital contents for which the collection request is input are collected when scanning the QR code 12, and a collection list output unit 160 outputting a list for the collected digital contents and a list for digital contents which are not collected in communication with the collection content DB 230, and
the manager server 200 includes
a user information DB 210 storing the user information transmitted from the user information input unit 110,
an original content DB 220 prestoring the digital contents based on the information stored in the NFC tag 11, and
a collection content DB 230 storing the collection information for the collected digital contents by scanning the QR code 12.

2. The system of claim 1, wherein the user terminal 100 further includes
a collection information output unit 170 outputting detailed information including information on titles and categories for the collected digital contents in communication with the collection content DB 230, and
a non-collection information output unit 180 outputting detailed information including information on a purchase cost and a purchase place for a product 10 which is accessible to the digital contents which are not collected in communication with the collection content DB 230.

3. The system of claim 2, wherein the user terminal 100 further includes
an execution request input unit 135 receiving an execution request of the digital contents based on the information stored in the NFC tag 11 in communication with the original content DB 220 when reading the NFC tag 11 attached to the product 10.

4. The system of claim 3, wherein the collection completion guide unit 150 receives a payment request when scanning the QR code 12 by means of the camera module when the digital contents for which the collection request is input are paid, and informs that digital contents for which payment is completed by performing payment are collected, and
the manager server 200 further includes a payment management unit 240 for managing a process related to the payment of the digital contents which are paid.

5. The system of claim 4, wherein the manager server 200 further includes
an advertisement providing unit 250 providing an advertisement for the product in which the user is sufficiently interested by analyzing the user information stored in the user information DB 210 and the digital contents stored in the collection content DB 230.

6. The system of claim 5, wherein the collection list output unit 160 outputs thumbnail images for the collected digital contents with a color and outputs a thumbnail image for the digital contents which are not collected with black and white.

7. A method for collecting a digital content,
comprising: a user information input step S100 of receiving, a user terminal 100, user information;
a user information transmission step S200 of transmitting the received user information to a user information DB 210;
a content categorization output step S300 of categorizing and outputting to user terminal 100 information on all digital contents in communication with an original content DB 220;
an NFC tag reading step S400 of reading an NFC tag 11 attached to a product 10 or enclosed along with the product 10;
a user request input step S500 of receiving a collection request or an execution request of digital contents based on information stored in the read NFC tag 11 in communication with the original content DB 220;
a shooting screen output step S600 of outputting, to the user terminal 100, to a shooting screen of a camera module for scanning a QR code 12 attached to the product 10 or enclosed along with the product 10 when receiving the collection request;
a collection content storing step S700 in which when scanning the QR code 12, i) when the digital contents for which the collection request is input are free, the digital contents are immediately stored in the collection content DB 230, and ii) when the digital contents for which the collection request is input is paid, a payment request is received and digital contents for which payment is completed by performing payment are stored in the collection content DB 230;
a collection completion guide step S800 of informing the user terminal 100 that the digital contents stored in the collection content DB 230 are collected;
a collection list output step S900 of outputting, to the user terminal 100, a list for collected digital contents and a list for digital contents which are not collected in communication with the collection content DB 230;
a collection information output step S1000 of outputting, to the user terminal 100, detailed information including information on titles and categories for the collected digital contents in communication with the collection content DB 230;
a non-collection information output step S1100 of outputting, to the user terminal 100, detailed information including information on a purchase cost and a purchase place for the product 10 which is accessible to the digital contents which are not collected in communication with the collection content DB 230; and
an advertisement providing step S1200 of providing, to the user terminal 100, an advertisement for a product in which a user is sufficiently interested by analyzing the user information stored in the user information DB 210 and the digital contents stored in the collection content DB 230.
